(19) United States
(12) Patent Application Publication
(10) Pub. No.: US 2026/0323547 A1
(43) Pub. Date: Oct. 15, 2026

(54) WIRELESS STATION SYNCHRONIZATION VIA BACKHAUL CONNECTIVITY

(71) Applicant: Charter Communications Operating, LLC, St. Louis, MO (US)

(72) Inventor: Saran Khalid, Denver, CO (US)

(21) Appl. No.: 19/175,175

(22) Filed: Apr. 10, 2025

(51) Int. Cl. H04W 56/00

(52) U.S. Cl. CPC H04W 56/0015

(57) ABSTRACT

A communication management resource monitors an ability of a first wireless base station to synchronize itself with respect to a wireless network. Assume that the communication management resource detects a failure condition, preventing the first wireless base station from synchronizing itself with the wireless network based on one or more satellite signals. In response to detecting this condition, the communication management resource updates the synchronization of the first wireless base station with respect to the wireless network based upon synchronization information received from a second wireless base station over a backhaul of the wireless network. In other words the second wireless base station synchronizes itself with the wireless network via a received satellite signal; the first wireless base station synchronizes itself with the wireless network based on synchronization information received over the backhaul from the second wireless base station.

### BACKGROUND

Conventional networks may include multiple wireless base stations. The wireless base stations provide mobile communication devices (a.k.a., user current) wireless access to a remote network through a backhaul. It is desirable that the wireless base stations be synchronized with each other to support best use of available wireless channels.

### BRIEF DESCRIPTION OF EXAMPLES

In certain instances, each of multiple wireless base stations in a network environment may include a wireless interface to receive GPS (Mobile Positioning System) signals transmitted by a respective satellites. The GPS signals may be used by the wireless base stations to synchronize themselves with each other. Such wireless interfaces receiving the GPS signals may be damaged due to weather or other reasons. In such an instance, a respective wireless base station is unable to synchronize itself with the other wireless base stations that are synchronize based on the GPS signals transmitted by one or more satellites.

This disclosure recites techniques to support synchronization of a first wireless base station with a wireless network during conditions in which the first wireless base station itself is unable to synchronize with the wireless network via receipt of a satellite signal (a.k.a. GPS signals). In other words, a first wireless base station in the network environment as discussed herein may experience an inability to synchronize itself with the wireless network and member wireless base stations based on disablement or failure of the first wireless base station's respective wireless interface that is normally used to receive one or more satellite signals supporting synchronization.

In order to ensure that the failing wireless base stations are able to provide continued wireless access, techniques herein provide implementation of a (backup) time sync source during conditions when a respective wireless base station is unable to receive the one or more satellite signals.

The backup time sync source can be any suitable entity. In one example, the backup time sync source is a second wireless base station already synchronized with the wireless network via the second wireless base station receiving the satellite signal. The first wireless base station including the failed wireless interface synchronizes itself based on a process including one or more operations such as: providing a message when hold over time is expiring to neighbors, neighbors responding and picking one neighbor to achieve time synchronization; use nearest neighbor wireless base station in terms of distance to receive time synchronization information; compare two wireless base stations and pick the best or use combination of both wireless base stations to support time synchronization, and so on.

Accordingly, techniques herein include providing improved wireless connectivity in a network such as via better use of available wireless resources during failure conditions.

For example, a network environment as discussed herein can be configured to include a wireless network. The wireless network may include any number of wireless base stations such as a first wireless base station, second wireless base station, etc. The first wireless base station can be configured to include a communication management resource that manages synchronization of the first wireless base station with the wireless network and corresponding wireless base stations.

More specifically, to support continued synchronization of the first wireless base station with the rest of the wireless base stations in the wireless network, the communication management resource associated with the first wireless base station monitors synchronization of the first wireless base station with respect to a wireless network. In one example, the communication management resource detects a condition (such as a failure associated with the first wireless base station or other entity) preventing the first wireless base station from updating synchronization of the first wireless base station with the wireless network. In response to detecting the condition, the communication management resource updates the synchronization of the first wireless base station with respect to the wireless network based upon synchronization information received from a synchronization source over a backhaul of the wireless network.

In one example, the communication management resource at or associated with the first wireless base station monitors receipt of wireless signals from one or more satellites. The condition preventing the updating of the synchronization of the first wireless base station with the wireless network may include an inability of the first wireless base station and corresponding wireless interface to receive wireless signals from one or more satellites. In other words, the first wireless base station made the unable to receive satellite signals to synchronize the first wireless base station with the other wireless base stations in the wireless network.

The second wireless base station or other suitable entity can be configured to be a backup synchronization source available to the failing first wireless base station. For example, the backup synchronization source such as associated with the second wireless base station may be able to successfully receive wireless signals from the satellite and synchronize itself with other wireless base stations in the wireless network. In other words, the second wireless base station does not experience a failure and is able to receive the one or more satellite signals to synchronize itself with the wireless network.

As further discussed herein, updating the synchronization of the first wireless base station with respect to the wireless network may include the first wireless base station transmitting a notification to the second wireless base station, which implements a backup synchronization source of providing synchronization information. The notification may be in response to detecting an inability of the first wireless base station to receive wireless timing signals from the one or more satellites.

Yet further, in another example, updating the synchronization of the first wireless base station with respect to the wireless network may include the first wireless base station transmitting a request to a second wireless base station, where the request is a request to handoff first user equipment (such as an imaginary instance of user equipment) from the first wireless base station to the second wireless base station. As previously discussed, the synchronization source providing synchronization information may be disposed at the second wireless base station or other suitable location. In response to transmitting the request, the first wireless base station receives the synchronization information from the synchronization source such as disposed at the second wireless base station. The synchronization information may include a reference clock setting associated with the second wireless base station. The reference clock setting is derived based on the second wireless base station receiving wireless satellite signals from the one or more satellites.

In a further example, the first wireless base station can be configured to adjust the received reference clock setting based upon a time delay associated with communicating the reference clock setting over a communication path from the second wireless base station to the first wireless base station.

Still further, the first instance of the user equipment as discussed herein may be an imaginary mobile communication device. In other words, the imaginary mobile communication device may be an emulation of the first user equipment.

In accordance with further examples, in response to the first wireless base station or other suitable entity detecting the condition preventing the first wireless base station from updating synchronization of the first wireless base station with the wireless network, the first wireless base station can be configured to communicate a handoff request to the second wireless base station. In one example, the handoff request requests a handoff of an imaginary instance of user equipment from the first wireless base station to the second wireless base station. The requested handoff results in the first wireless base station receiving synchronization information from the second wireless base station, where the synchronization information enables the first wireless base station to synchronize itself with the wireless network.

Examples herein are useful over conventional techniques. For example, implementation of the backup synchronization source and emulated handoff of a user equipment from the first wireless base station to the second wireless base station results in the first wireless base station receiving synchronization information to update synchronization of the first wireless base station with the wireless network, which includes the second wireless base station.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different examples as described herein.

Yet other examples herein include software programs to perform the steps and operations summarized above and disclosed in detail below. One such example comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, examples herein are directed to a method, system, computer program product, etc., that supports operations as discussed herein.

One example includes a computer readable storage medium and/or system having instructions stored thereon. The instructions, when executed by the computer processor hardware, cause the computer processor hardware (such as one or more co-located or disparately processor devices or hardware) to: monitor synchronization of a first wireless base station with respect to a wireless network; detect a condition preventing the first wireless base station from updating synchronization of the first wireless base station with the wireless network; and in response to detecting the condition, update the synchronization of the first wireless base station with respect to the wireless network based upon synchronization information received over a backhaul of the wireless network.

The ordering of the steps above has been added for clarity sake. Note that any of the processing steps as discussed herein can be performed in any suitable order.

Other examples of the present disclosure include software programs and/or respective hardware to perform any of the method example steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless connectivity in a network environment. However, it should be noted that examples herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of examples herein (BRIEF DESCRIPTION OF EXAMPLES) purposefully does not specify every example and/or incrementally novel aspect of the present disclosure or claimed invention(s). Instead, this brief description only presents general examples and corresponding points of novelty over conventional techniques. For additional details and/or possible perspectives (permutations) of the invention(s), the reader is directed to the Detailed Description section (which is a summary of examples) and corresponding figures of the present disclosure as further discussed below.

### BRIEF DESCRIPTION OF THE DRAWINGS

FIG. 1 is an example diagram illustrating synchronization of a network of wireless base stations via one or more wireless satellite signals as discussed herein.

FIG. 2 is an example top view diagram of the network of wireless base stations as discussed herein.

FIG. 3 is an example diagram illustrating details of each of multiple wireless base stations disposed in a wireless network as discussed herein.

FIG. 4 is an example diagram illustrating details of a communication management resource managing multiple wireless base stations as discussed herein.

FIG. 5 is an example diagram illustrating an inability of a wireless base station and corresponding communication management resource to synchronize the wireless base station with a respective wireless network as discussed herein.

FIG. 6 is an example diagram illustrating an inability of a respective wireless base station and corresponding communication management resource from using a satellite signal to synchronize itself with a wireless network and implementation of a dummy user equipment emulation function to support synchronization as discussed herein.

FIG. 7 is an example flow chart diagram illustrating communications amongst multiple entities in a wireless network, where the communications support a backup method of synchronizing a wireless base station with the wireless network as discussed herein.

FIG. 8 is an example diagram illustrating example computer hardware and software operable to execute operations as discussed herein.

FIG. 9 is an example diagram illustrating a method of providing backup synchronization to a failed wireless base station as discussed herein.

The foregoing and other objects, features, and advantages of the invention will be apparent from the following more particular description of preferred examples herein, as illustrated in the accompanying drawings in which like reference characters refer to the same parts throughout the different views. The drawings are not necessarily to scale, with emphasis instead being placed upon illustrating the examples, principles, concepts, etc.

### DESCRIPTION OF EXAMPLES

A communication management resource monitors an ability of a first wireless base station to synchronize itself with respect to a wireless network. Assume that the communication management resource detects a condition (such as a failure associated with the first wireless base station receiving wireless satellite signals) preventing the first wireless base station from synchronizing itself with the wireless network.

In response to detecting this condition, the communication management resource updates the synchronization of the first wireless base station with respect to the wireless network based upon synchronization information received from a synchronization source (such as a second wireless base station in the wireless network) over a backhaul of the wireless network. The synchronization source may be or may be disposed at a second wireless base station in the wireless network. In such an instance, the first wireless base station synchronizes itself with the wireless network based on synchronization information received over the backhaul from the second wireless base station. The second wireless base station can be configured to generate the synchronization information based on the second wireless base station receiving and processing the transmitted wireless satellite signals.

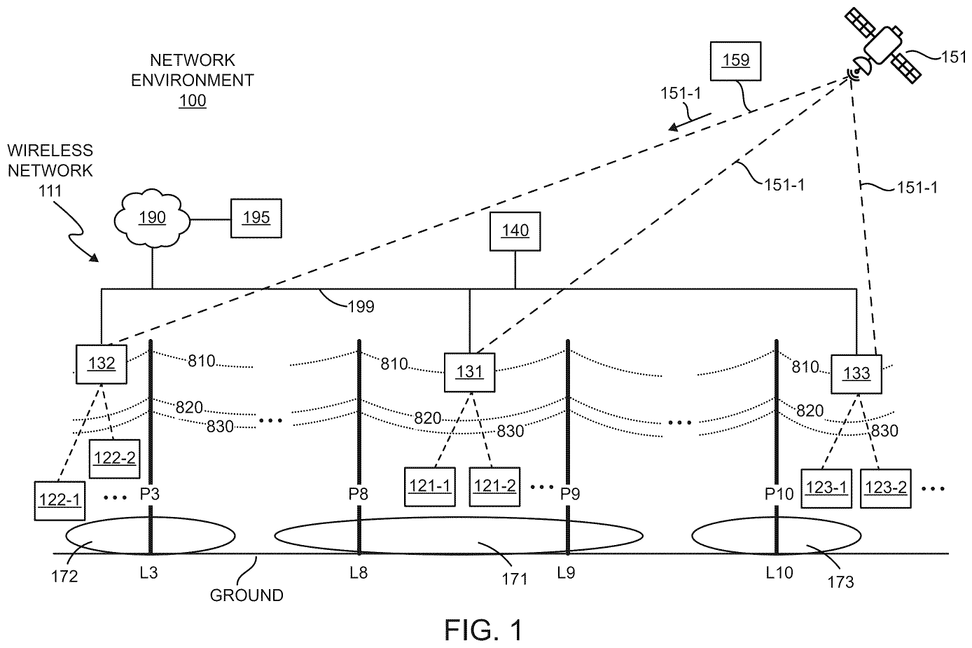

Now, with reference to the drawings, FIG. 1 is an example diagram illustrating synchronization of a network of wireless base stations via one or more wireless satellite signals as discussed herein.

As shown in this example, the wireless network environment 100 includes multiple wireless communication devices such as satellite 151, wireless base station 131, wireless base station 132, wireless base station 133, . . . , mobile communication device 121-1, . . . , mobile communication device 122-1, mobile communication device 122-2, . . . , mobile communication device 123-1, mobile communication device 123-2, and so on.

Network environment 100 may include any number of satellites supporting transmission of synchronization information over wireless signals.

Additionally, the network environment 100 includes backhaul 199 such as wired or wireless communication link supporting connectivity amongst one or more of the wireless base stations 131, 132, 133, etc., communication management resource 140, remote network 190, etc.

As further shown, the wireless base station 131 supports a region of wireless coverage 171. This means that the wireless base station 131 generally can wirelessly communicate (receive communications and transmit communications) with any mobile communication devices (such as mobile communication device 121-1, mobile communication device 121-2, etc.) residing within the region of wireless coverage 171. Of course, the size of the region of wireless coverage 171 depends upon a respective wireless power level at which the wireless base station 131 and corresponding mobile communication devices 121-1, 121-2, etc., transmit respective wireless signals between each other.

The wireless base station 132 supports a region of wireless coverage 172. This means that the wireless base station 132 generally can wirelessly communicate (receive communications and transmit communications) with any mobile communication devices residing 122-1, 122-2, etc., within the region of wireless coverage 172. Of course, the size of the region of wireless coverage 172 depends upon a respective wireless power level at which the wireless base station 132 and corresponding mobile communication devices 122-1, 122-2, etc., transmit respective wireless signals between each other.

It is noted that each of the regions of wireless coverage in the network environment 100 may at least partially overlap each other or not overlap each other at all.

Thus, the wireless network 111 includes wireless base station 131, wireless base station 132, wireless base station 133, etc. The wireless base stations in the wireless network 111 can be configured to wirelessly communicate with respective mobile communication devices in accordance with any suitable wireless communication protocol. In one example, the wireless base stations and mobile communication devices in wireless network 111 implement private 5G or LTE (Long Term Evolution) wireless protocols to support wireless communications.

In a further non-limiting example, each of the wireless base stations in the wireless network 111 support communications via use of one or more wireless channels in the CBRS (Citizens Broadband Radio Service). In such an instance, the wireless base stations in the wireless network 111 must discontinue using their allocated one or more wireless channels during an instance in which a respective higher priority incumbent entity uses those wireless channels.

The wireless base stations in the wireless network 111 may use the same or different wireless channels to support wireless communications with respective one or more mobile communication devices.

Further, it is noted that the wireless base stations 131, 132, and 133, etc., as discussed herein can be implemented in any suitable manner. In one example, each of the wireless base stations is coupled to a respective strand of wire such as extending between a first telephone pole and a second telephone pole ( . . . , P3, P8, P9, P10, . . . ).

Additionally, or alternatively, any of the wireless base stations in the wireless network 111 may be disposed on a respective tower or other above ground physical structure.

It is desirable that the wireless base stations in the wireless network be synchronized with each other based on a master clock. Synchronization of the wireless base stations in the wireless network 111 to the common master clock improves communication quality and reduces overall wireless interference in the network environment 100.

As previously discussed, the wireless base stations can be disposed and any of the wireless in the poles in the network environment 100. For example, the wireless base station 131 can be disposed (connected to) or installed on the wire 810 (strand) extending between the pole P8 and pole P9; wireless base station 132 can be disposed or installed on the wire 810 near pole P3; the wireless base station can be disposed or installed on the wire 810 near pole P10; and so on.

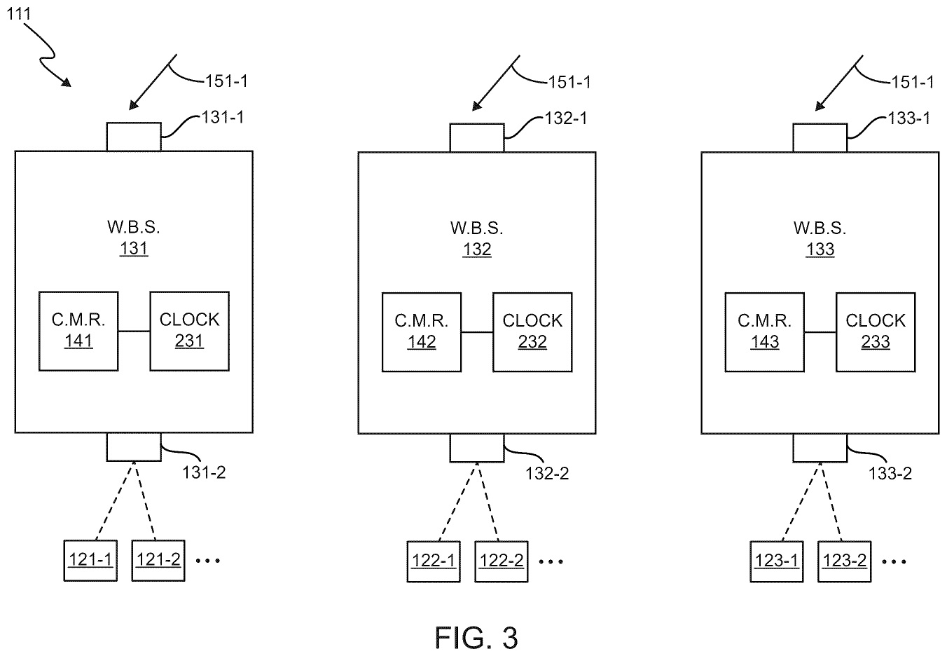

Additional details of the wireless base stations in the wireless network 111 are shown and discussed in FIG. 3.

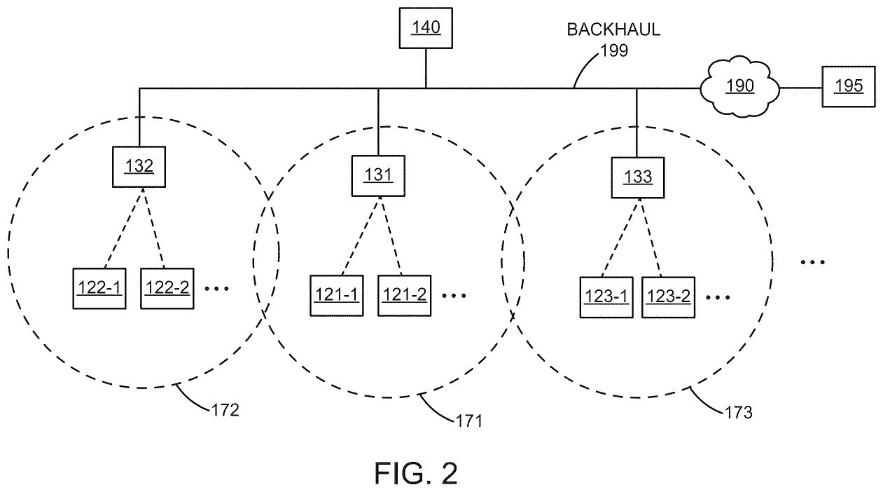

FIG. 2 is an example top view diagram of the network of wireless base stations as discussed herein.

As previously discussed, the first wireless base station 131 provides the region of wireless coverage 171 and corresponding wireless connectivity to mobile communication device 121-1, mobile communication device 121-2, etc.; the second wireless base station 132 provides the region of wireless coverage 172 and corresponding wireless connectivity to the mobile communication device 122-1, mobile communication device 122-2, etc.; the wireless base station 133 provides the region of wireless coverage 173 and corresponding wireless connectivity to the mobile communication device 123-1, mobile communication device 123-2, etc.

The regions of wireless coverage may be completely overlapping, partially overlapping or non-overlapping.

FIG. 3 is an example diagram illustrating details of each of multiple wireless base stations disposed in a wireless network as discussed herein.

In this example, the wireless base station 131 includes communication management resource 141. As its name suggests, the communication management resource 141 associated with the wireless base station 131 manages operation of the wireless base station 131 such that the wireless base station 131 supports wireless connectivity to multiple mobile communication devices 121-1, 121-2, etc., via the antenna hardware 131-2.

As further shown, the wireless base station 131 includes the wireless interface 131-1 (antenna hardware and corresponding circuitry) supporting receipt of wireless communications 151-1 (including timing synchronization information) transmitted by the respective satellite 151 or other entity.

Yet further, the wireless base station 131 includes the master clock 231, which is used by the communication management resource 131 and corresponding communication management resource 141 to control timing of transmitting and receiving wireless communications associated with the wireless base station 131.

In this example, the wireless base stations receive wireless communications 151-1 transmitted by the respective satellite 151. In one example, the wireless communications 151-1 are GPS signals including timing/synchronization information used by the wireless base stations in the wireless network 111 for synchronization purposes.

More specifically, the wireless base station 131 receives the wireless communications 151-1 transmitted from the satellite 151. The wireless base station 131 uses the received timing information in the wireless communications 151-1 to set its master clock 231.

Further in this example, the wireless base station 132 includes communication management resource 142. As its name suggests, the communication management resource 142 associated with the wireless base station 132 manages operation of the wireless base station 132 such that the wireless base station 132 supports wireless connectivity to multiple mobile communication devices 122-1, 122-2, etc., via the antenna hardware 132-2.

As further shown, the wireless base station 132 includes the wireless interface 132-1 (antenna hardware and corresponding circuitry) supporting receipt of wireless communications 152-1 (including timing synchronization information) transmitted by the respective satellite 152 or other entity.

Yet further, the wireless base station 132 includes the master clock 232. The wireless base station 132 receives the wireless communications 151-1 transmitted from and received by the satellite 151. The wireless base station 132 uses the received timing information in the wireless communications 151-1 to set its clock 232.

Accordingly, in a similar manner as previously discussed, each of the wireless base stations in the wireless network 111 can be configured to synchronize their corresponding master clocks using the received GPS signals (communications 151-1), where each of the recipient wireless base stations in the wireless network 111 processes the received wireless signals 151-1 from one or more satellites 151, and further where the communications 151-1 include highly accurate time information from atomic clocks associated with the satellite 151. Each recipient wireless base station (131, 132, 133, etc.) then adjusts its local clock (231, 232, 233, etc.) to match the master clock of the satellite 151.

In other words, via the communications 151-1, each of the wireless base stations in the wireless network 111 synchronizes to a common master clock. That is, each of the clocks 231, 232, 233, etc., are substantially set to the same value based on receipt of the timing/synchronization information in wireless signal 151-1.

The clocks 231, 232, 233, etc., associated with the wireless base stations of wireless network 111 may drift apart over time due to circuit inaccuracies. In such an instance, it is desirable for each of the wireless base stations in the wireless network 111 to occasionally resynchronize themselves to the master clock of the satellite 151 such that all of the wireless base stations in the wireless network 111 are synchronized with each other over and over again.

Referring again to FIG. 1 and FIG. 3, during operation, the wireless base station 131 implements the antenna hardware 131-2 to communicate with one or more mobile communication devices such as mobile communication device 121-1, mobile communication device 121-2, etc.

As previously discussed, the wireless base station 131 and corresponding antenna hardware 131-2 support the region of wireless coverage 171 in the network environment 100.

The wireless base station 131 is in wireless communication with each of the mobile communication devices 121-1, 121-2, etc., over a respective wireless communication link.

Accordingly, in an upstream direction, the wireless base station 131 is able to receive upstream wireless communications transmitted from the mobile communication device 121-1. The wireless base station 131 forwards those received wireless upstream communications over the shared backhaul 199 and the remote network 190 to a respective target such as server resource 195 or other suitable entity. The shared backhaul 199 may be wired or wireless.

In a reverse direction (a.k.a., downstream direction), the server resource 195 or other suitable entity in the network environment 100 transmits downstream communications destined for delivery to the mobile communication device 121-1 over the remote network 190 and the backhaul 199 to the wireless base station 131. The wireless base station 131, in turn, wirelessly transmits those downstream communications over a respective wireless communication link to the mobile communication device 121-1.

As previously discussed, the wireless base station 132 and corresponding antenna hardware 132-2 support the region of wireless coverage 172 in the network environment 100

The wireless base station 132 is in wireless communication with each of the mobile communication devices 122-1, 122-2, etc., over a respective wireless communication link.

Accordingly, in an upstream direction, the wireless base station 132 is able to receive upstream wireless communications transmitted from the mobile communication device 122-1. The wireless base station 132 forwards those received wireless upstream communications over the shared backhaul 199 and the remote network 190 to a respective target such as server resource 195 or other suitable entity. The shared backhaul 199 may be wired or wireless.

In a reverse direction (a.k.a., downstream direction), the server resource 195 or other suitable entity in the network environment 100 transmits downstream communications destined for delivery to the mobile communication device 122-1 over the remote network 190 and the backhaul 199 to the wireless base station 132. The wireless base station 131, in turn, wirelessly transmits those downstream communications over a respective wireless communication link to the mobile communication device 122-1.

Each of the wireless base stations in the wireless network 111 operate in a similar manner such that mobile communication devices wirelessly connected to the respective wireless base station are able to access the remote network 190.

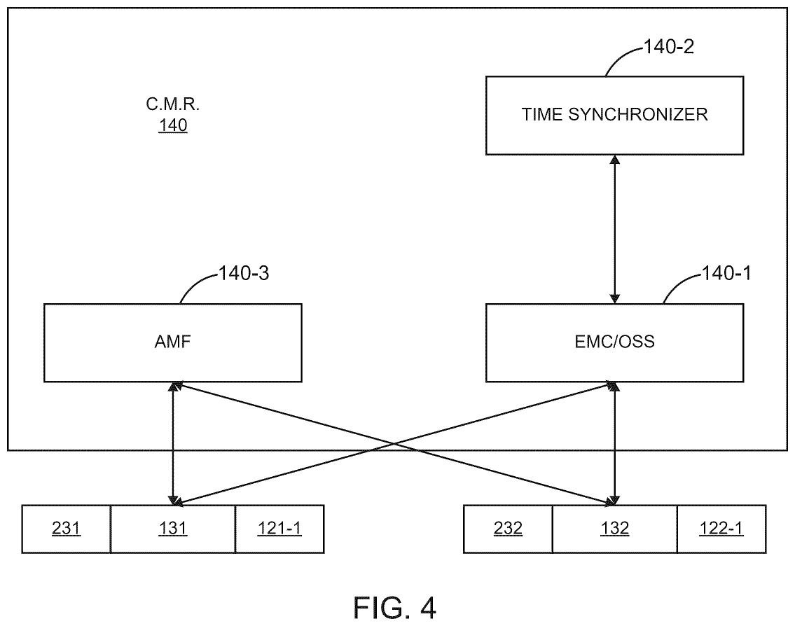

Additional details of the communication management resource 140 supporting management of communications in the network environment 100 shown in FIG. 4 and discussed in detail below.

More specifically, FIG. 4 is an example diagram illustrating details of a communication management resource managing the wireless network of multiple wireless base stations as discussed herein.

As previously discussed, the communication management resource 140 can be configured to support management of conveying communications in the network environment 100. The management of conveying the communications may include functions such as management of one or more wireless channels allocated for use by the different wireless base stations, tracking which of multiple mobile communication devices are currently wirelessly connected to a respective wireless base station, etc.

In this example, the communication management resource 140 includes multiple components and corresponding functions such as communication management resource 140-1 (supporting a first communication management function), communication management resource 140-2 (supporting a second communication management function), communication management resource 140-3 (supporting a third communication management function), etc.

Each of the communication management resources associated with the communication management resource 140 supports different functions.

For example, the communication management resource 140-1 can be implemented to support one or more functions associated with an OSS (Operational Support System). The communication management resource 140-1 supports information processing systems used to manage the wireless network 111.

The communication management resource 140-2 can be implemented as a so-called time synchronizer function that supports synchronization of one or more wireless base stations in the wireless network 111 during conditions in which a respective wireless base station experiences a failure and is unable to use the wireless signal 151-1 to synchronize itself with the satellite 151 and, thus, other wireless base stations in the corresponding wireless network 111.

The communication management resource 140-1 can be implemented as a so-called Access and Mobility Management Function (AMF). The communication management resource 140-1 can be configured to terminate the control plane of different access networks onto the 5G Core Network(5GC) and control which instances of mobile communication devices (user equipment), which are able to access the 5GC to exchange traffic with DNs.

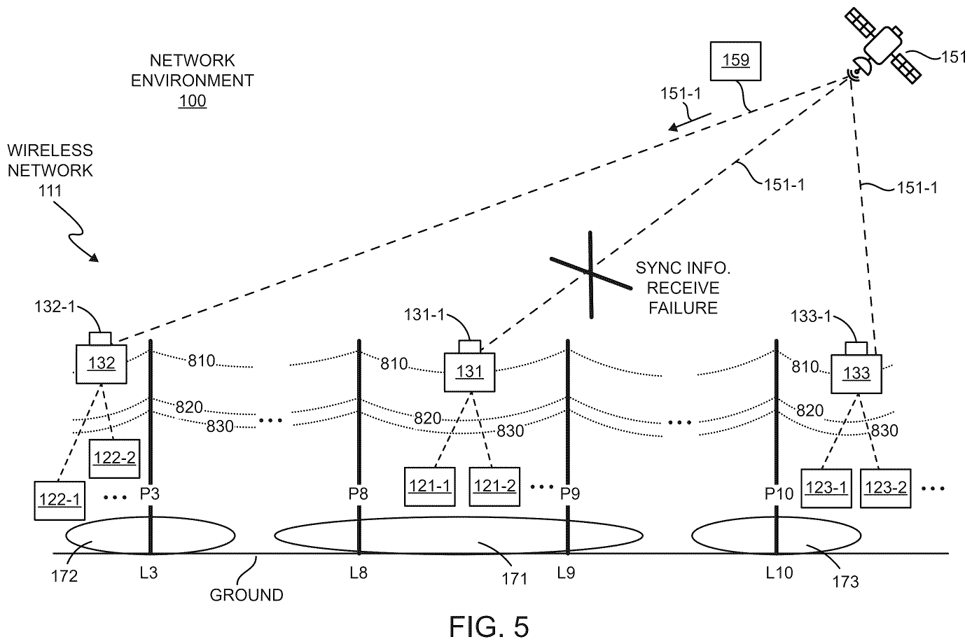

FIG. 5 is an example diagram illustrating an inability of a wireless base station and corresponding communication management resource to synchronize the wireless base station with a respective wireless network as discussed herein.

As previously discussed, it is desirable that each of the wireless base stations synchronize themselves with each other based upon receipt of the wireless communications 151-1 (such as including corresponding synchronization/timing information 159) transmitted by the satellite 151. However, in certain circumstances, a respective wireless base station may be unable to use the wireless communications 151-1 to update its own master clock.

In this example, assume that the wireless base station 131 is unable to receive the wireless communications 151-1 and update its respective master clock 231 based upon the timing/synchronization information 159 in the wireless medications 151-1. In such an instance, as further discussed below, the wireless base station 131 can be configured to implement a so-called dummy user equipment emulation function 121-UE to receive synchronization information from one or more other wireless base station to update its clock 231.

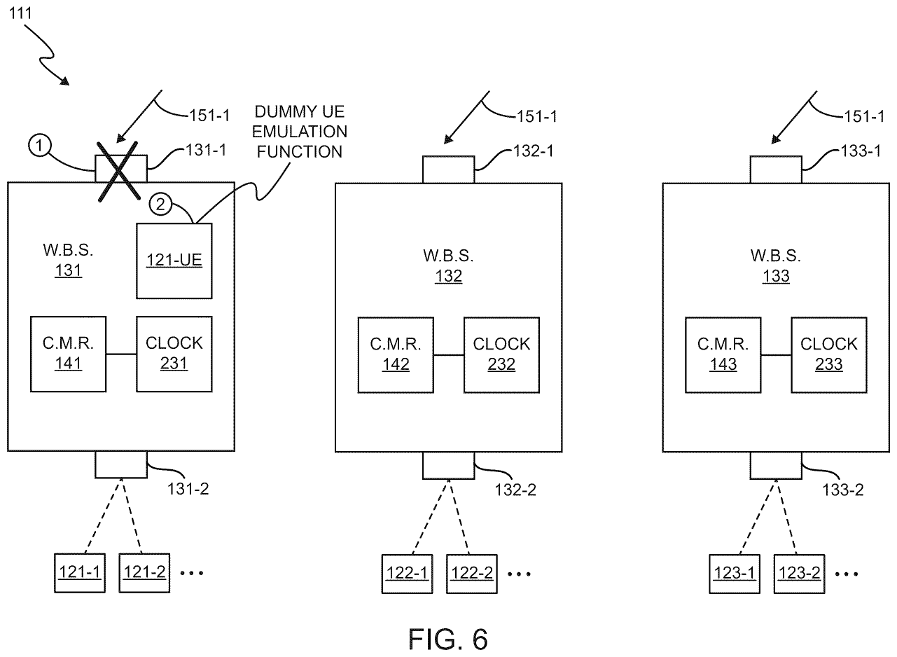

FIG. 6 is an example diagram illustrating an inability of a respective wireless base station from using a satellite signal to synchronize itself with a wireless network as discussed herein.

As shown, in processing operation #1, the wireless base station 131 is unable to resynchronize its master clock 231 based on receipt of the wireless communications 151-1 and corresponding timing/synchronization information 159 in the wireless communications 151-1. This may occur as a result any condition such as wireless communications 151-1 being blocked by a physical object, failure associated with the communication interface 131-1, etc.

Recall that the communication interface 131-1 is configured to support receipt of GPS satellite signals the corresponding timing/synchronization information 159.

In this example, in response to the communication management resource 141 detecting an inability to synchronize the clock 231 with the clocks of the other wireless base stations because of the failed ability to receive the wireless communications 151-1 such as via the wireless interface 131-1, the wireless base station 131 or other suitable entity executes the dummy user equipment emulation function 121-UE in operation #2.

In one example, as its name suggest, the executed dummy user equipment function 121-UE is an emulation (such as not real or imaginary instance of user equipment) of an instance of user equipment in communication with the wireless base station 131 over a respective wireless communication link. The execution of the dummy user equipment function 121-UE (imaginary user equipment) enables the wireless base station 131 to receive timing/synchronization information from one or more other wireless base stations in the wireless network 111, where the received timing/synchronization information from the one or more other wireless base stations is used to update the clock 231 to be substantially equal to respective settings of the other clocks to 232, 233, etc.

In one example, the wireless base station 132 can be configured to receive the wireless communications 151-1 and corresponding timing/synchronization information 159. The wireless base station 132 can be configured to communicate this information over the backhaul 199 to the wireless base station 131. Techniques herein may include determining a time difference between the time of the wireless base station 132 transmitting the timing/synchronization information 159 and a time of the wireless base station 131 receiving the timing/synchronization information 159. In such an instance, the communication manager resource 141 and corresponding wireless base station 131 can be configured to adjust the received timing/synchronization information 159 based upon the determined time difference and use such information to update the clock 231.

Additional details associated with the wireless base station 131 synchronizing itself with the other wireless base stations in the wireless network 111 is further discussed below.

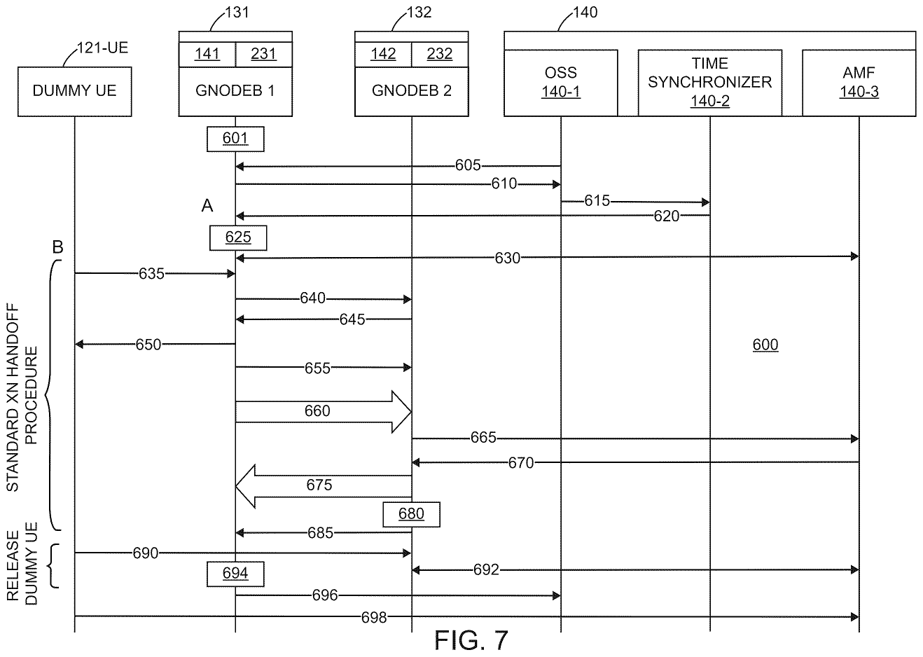

FIG. 7 is an example flow chart diagram illustrating communications amongst multiple entities in a wireless network, where the communications support a backup method of synchronizing a wireless base station with the wireless network as discussed herein.

Flowchart 600 illustrates operations associated with updating the synchronization of the master clock 231 associated with the wireless base station 131 and corresponding communication management resource 141 during a condition in which the wireless base station 131 is unable to receive and process the wireless communications 151-1 to update the master clock 231.

In processing operation 601, the communication management resource 141 of the wireless base station 131 detects an inability of the wireless base station 131 or corresponding wireless interface 131-1 from receiving the wireless communications 151-1. In response to detecting the inability, the communication management resource 141 associated with the wireless base station 131 generates an alarm notification. The alarm notification indicates that the wireless base station 131 and corresponding communication management resource 141 are unable to update synchronization of the clock 231 with the timing/synchronization information 159 transmitted from the satellite 151.

It is desirable that the clock 231 be continuously updated based on the clock associated with the satellite 151 to synchronize with other clocks 232, 233, etc., associated with the other wireless base stations in the wireless network 111.

The communication management resource 140-1 can be configured to repeatedly communicate with any of the wireless base stations to determine if they are unable to use the one or more wireless satellite communications transmitted from the satellite 151 to update their respective clocks. In this example, via communications 605, the communication management resource 140-1 communicates a request to collect any alarm notifications from the wireless base station 131. As previously discussed, in this example, the wireless base station 131 previously generated a respective alarm notification indicating that is unable to use the wireless communications 151-1 or other satellite signals to update its master clock 231 to support wireless communications with mobile communication devices 121-1, 121-2, etc.

Via communications 610, in response to receiving the communications 605, the wireless base station 131 and corresponding communication management resource 141 notify the communication management resource 140-1 that the wireless base station 131 and corresponding communication management resource 141 are unable to update synchronization of the clock 231 using any firsthand received satellite information from the satellite 151. Accordingly, the communication management resource 140-1 is made aware that the wireless base station 131 is no longer capable of synchronizing itself with the other wireless base stations using the wireless communications 151-1 from the satellite 151.

In response to detecting the notification alarm associated with the wireless base station 131, the communication management resource 140-1 transmits communications 615 to the communication management resource 140-2. In one example, the communications 615 notify the communication management resource 140-2 that the wireless base station 131 and corresponding communication management resource 141 are unable to update synchronization of the clock 231 with the other wireless base stations in the wireless network 111.

In response to the communications 615, the communication management resource 140-2 transmits communications 620 to the wireless base station 131 and corresponding communication management resource 141. In one example, the communications 620 initiate execution of the dummy user equipment function 121-UE, which supports a fake or emulated or simulated handoff of an instance of user equipment from the wireless base station 131 to the wireless base station 132. In one example, the dummy user equipment function 121-UE simulates hardware and software functions associated with a respective instance of non-existent user equipment.

In processing operation 625, in response to receiving the communications 620 indicating to execute a fake or dummy handoff of an emulated instance of user equipment from the wireless base station 131 to the wireless base station 132, the wireless base station 131 and corresponding communication management resource 141 or other suitable one or more entities initiate execution of the dummy user equipment function 121-UE. Thus, in one example, the emulated user equipment as supported by the executed dummy user equipment function 121-UE is executed at the wireless base station 131 or other suitable entity.

Via communications 630 between the wireless base station 131 and the communication management resource 140-3, the wireless base station 131 and corresponding communication management resource 141 register the fake user equipment (mobile communication device) associated with the dummy user equipment function 121-UE as being connected to the wireless base station 131.

Further, via communications 635, the executed dummy user equipment function 121-UE provides a measurement report to the communication management resource 141 of the wireless base station 131. The management report can indicate that the instance of user equipment associated with the dummy user equipment function 121-UE is unable to receive communications from the wireless base station 131 above a threshold level. Of course, because the instance of user equipment associated with the dummy user equipment function 121-UE is not real, the fake report generated by the dummy user equipment function 121-UE is only generated to initiate a fake handoff of the dummy user equipment from the wireless base station 131 to the wireless base station 132.

In response to receiving the measurement report the communications 635, which indicates that the dummy user equipment associated with the dummy user equipment function 121-UE is below a threshold level, indicating that the dummy user equipment needs to be handed off from the wireless base station 131 to the wireless base station 132, the wireless base station 131 corresponding communication management resource 141 transmits communications 640 to the wireless base station 132 and corresponding communication management resource 142. In one example, the communications 640 include a request generated by the wireless base station 131 or other suitable entity to handoff the dummy user equipment associated with the dummy user equipment function 121-UE from the wireless base station 131 to the wireless base station 132.

In response to receiving the communications 640, the wireless base station 132 and corresponding communication management resource 142 transmit communications 645 to the wireless base station 131 corresponding communication management resource 141. In one example, the communications 645 indicate a handoff response generated by the wireless base station 132 and corresponding communication management resource 142. The handoff response in communications 645 may indicate positive notification that the wireless base station 132 is able to accept the handoff of the dummy user equipment as emulated by the dummy user equipment function 121-UE from the wireless base station 131.

In response to receiving communications 645, the wireless base station 131 and corresponding communication management resource 141 transmits communications 650 to the dummy user equipment function 121-UE emulating the dummy user equipment. The communication 650 are delivered to the dummy user equipment function 121-UE. The communications 650 indicate that the user equipment is to handoff from the wireless base station 131 to the wireless base station 132.

Via communications 655, the wireless base station 131 and corresponding communication management resource 141 notifies the wireless base station 132 of the transfer or handoff of the dummy user equipment associated with the dummy user equipment function 121-UE from the wireless base station 131 to the wireless base station 132.

Via communications 660, the wireless base station 131 and corresponding communication management resource 141 communicates fake buffered downlink data and corresponding forwarding request for time synchronization information to the wireless base station 132 and corresponding communication management resource 142.

In response to receiving communications 660, the wireless base station 132 transmits communications 665 to the communication management resource 140-3. In one example, the communications 665 include a path switch request associated with handoff of the dummy user equipment from the wireless base station 131 to the wireless base station 132.

Via communications 670, the communication management resource 140-3 notifies the wireless base station 132 of the receipt of the path switch request in communications 665.

Further, in response to receiving the acknowledgment of the path switch request in communications 670, which may indicate granting of the path switch request and corresponding connection, the wireless base station 132 and corresponding communication management resource 142 transmit communications 675 from the wireless base station 132 to the wireless base station 131 and corresponding communication management resource 141. In one example, the communications 675 include downlink buffered data with GPS time synchronization information (such as timing/synchronization information 159 (as collected from the communications 151-1 as received by the wireless interface 132-1 of the wireless base station 132.

Thus, in one example, the communications 675 indicate a current setting of the clock 232 and the clock (timing/synchronization information 159) associated with the satellite 151. Via the received information in communications 675 such as the time synchronization information 159, or simply the setting of the master clock 232, the communication management resource 141 of the wireless base station 131 updates its clock 231 to be synchronized with the master clock associated with the satellite 151 and other clocks associated with other wireless base stations such as clocks 232, 233, etc.

In a further example, as previously discussed, it is noted that there may be a delay associated with a time of the wireless base station 132 and corresponding communication management resource 142 transmitting the communications 675 (including the time synchronization information or master clock information indicating a setting of the clock associated with the satellite 151 or the other clocks 232, 233, etc.) and the time of the wireless base station 131 and corresponding communication management resource 141 receiving the timing information in communications 675. For example, the timing information may indicate that the current setting of the satellite clock is 1:09:12.34592 (for example, the current hour equals 1, minutes equals 9, seconds equals 12.34592) when received by the wireless base station 132. The delay time conveying the synchronization information may be 0.45 second. In such an instance, the communication management resource 141 can be configured to set the current clock 231 to a value of the satellite clock plus the delay time which would be 1:09:12.79592) at a time of receiving the communications 675. In such an instance, the clock 231 is set to a value substantially equal to the other clocks 232, 233, etc.

In processing operation 680, the handoff of the dummy user equipment as indicated by the dummy user equipment function 121-UE is complete such that the wireless base station 132 and corresponding communication management resource 142 believe that they now provide wireless services to the dummy user equipment 121-UE.

Further, in response to the handover of the dummy user equipment function 121-UE to the wireless base station 132 and corresponding communication management resource 142, the communication management resource and wireless base station 132 transmit the communications 685 to the wireless base station 131 and corresponding communication management resource 141. In one example, the communications 685 include so-called user equipment context release information indicating completion of the handoff of the dummy user equipment 121-UE from the wireless base station 131 to the wireless base station 132.

As further shown, in furtherance of the handoff of the user equipment associated with the dummy user equipment function 121-UE from the wireless base station 131 to the wireless base station 132, the dummy user equipment function 121-UE (such as executed by the wireless base station 131 corresponding communication management resource 141) initiates a context release message transmission in communications 690 to the wireless base station 132 and corresponding communication management resource 142.

Via communications 692, the communication management resource 140-3 further communicates the dummy user equipment context release signaling to the wireless base station 132 and corresponding communication management resource 142.

In processing operation 694, as previously discussed, the wireless base station 131 uses the time synchronization information received in communications 675 to synchronize the clock 231 to the satellite 151 and other corresponding clocks 232, 233, etc.

As further shown, the wireless base station 131 and corresponding communication management resource 141 transmit communications 696 to the communication management resource 140-1. In one example, the communications 696 include a clear (reset) alarm notification providing notification to the communication management resource 140-1. The clear alarm notification in communications 696 notify the communication management resource 140-1 that the wireless base station 131 and corresponding clock 231 is now synchronized with the other clocks such as the clock associated with the satellite 151 and the clocks 232, 233, etc.

As further shown, the emulated user equipment and corresponding dummy user equipment function 121-UE can be configured to transmit communications 698 to the communication management resource 140-3. In one example, the communications 698 indicate completion of the handoff of the dummy user equipment 120-UE to the wireless base station 132.

Accordingly, the implementation of the false handoff of the dummy user equipment 121-UE from the wireless base station 131 to the wireless base station 132 results in conveyance of clock synchronization information communicated from the wireless base station 132 and corresponding communication management resource 142 to the wireless base station 131 and corresponding communication management resource 141 for setting of the clock 231. In other words, the handoff of the dummy user equipment results in synchronization of the clock 231 with the master clock associated with other wireless base stations in the wireless network 111 as well as the clock associated with the satellite 151.

If desired, subsequent to the handoff as previously discussed from the wireless base station 131 to the wireless base station 132, operation of the dummy user equipment 121-UE can be terminated because the wireless base station 131 and corresponding clock 231 is now synchronized with other wireless base stations in the wireless network 111. The wireless base station 132 or other suitable entity can be configured to notify any of the communication management resources 140-1, 140-2, 140-3, etc., regarding the termination of the dummy user equipment 121-UE.

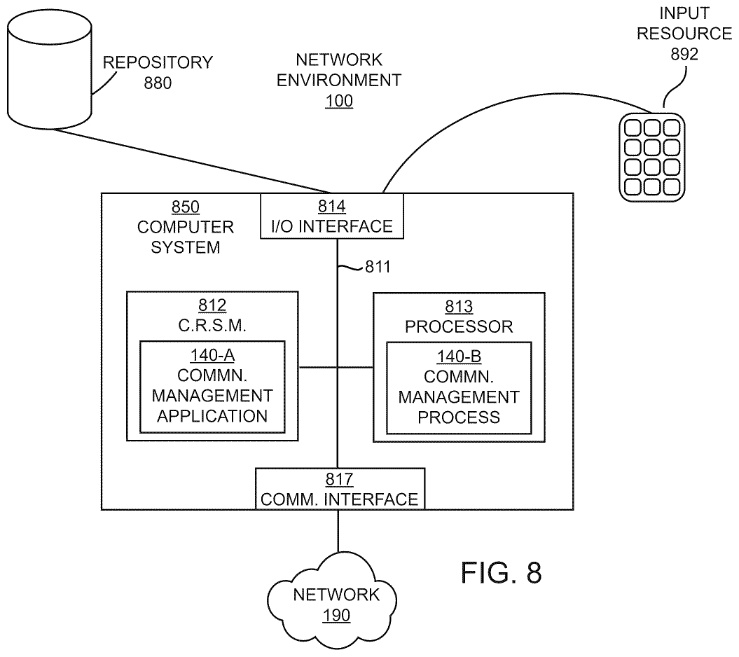

FIG. 8 is an example block diagram of a computer system for implementing any of the operations as previously discussed according to examples herein.

Note that any of the resources (such as communication management resource 141, communication management resource 140, communication management resource 140-1, communication management resource 140-2, communication management resource 140-3, communication management resource 142, communication management resource 143, dummy user equipment function 121-UE, etc.) as discussed herein can be configured to include computer processor hardware and/or corresponding executable instructions to carry out the different operations as discussed herein.

For example, as shown, computer system 850 of the present example includes interconnect 811 coupling computer readable storage media 812 such as a non-transitory type of media or any suitable type of computer readable hardware storage in which digital information can be stored and or retrieved, a processor 813 (computer processor hardware), I/O interface 814, and a communications interface 817.

I/O interface(s) 814 supports connectivity to repository 880 and input resource 892.

Computer readable storage medium 812 can be any hardware storage device such as memory, optical storage, hard drive, floppy disk, etc. In one example, the computer readable storage medium 812 stores instructions and/or data.

As shown, computer readable storage media 812 can be encoded with management application 140-A (e.g., including instructions) in a respective wireless station to carry out any of the operations as discussed herein.

During operation of one example, processor 813 accesses computer readable storage media 812 via the use of interconnect 811 in order to launch, run, execute, interpret or otherwise perform the instructions in management application 140-A stored on computer readable storage medium 812. Execution of the management application 140-A produces management process 140-B to carry out any of the operations and/or processes as discussed herein.

Those skilled in the art will understand that the computer system 850 can include other processes and/or software and hardware components, such as an operating system that controls allocation and use of hardware resources to execute the management application 140-A.

In accordance with different examples, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 850 may reside at any location or can be included in any suitable resource in any network environment to implement functionality as discussed herein.

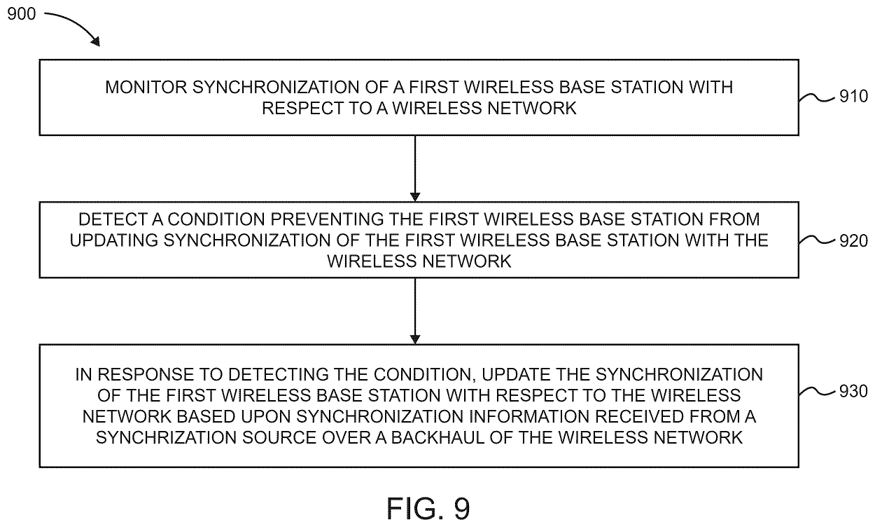

Functionality supported by the different resources will now be discussed via flowcharts in FIG. 9. Note that the steps in the flowcharts below can be executed in any suitable order.

FIG. 9 is a flowchart 900 illustrating an example method according to examples herein. Note that there will be some overlap with respect to concepts as discussed above.

In processing operation 910, the communication management resource at the first wireless base station 131 monitors synchronization of the first wireless base station 131 with respect to a wireless network 111.

In processing operation 920, the communication management resource 141 at the wireless base station 131 detects a condition preventing the first wireless base station 131 from updating synchronization of the first wireless base station 131 with the wireless network 111. In other words, the wireless base station 131 may experience a failure associated with the wireless interface 101 such that the wireless base station 131 is unable to synchronize itself with the wireless network 111 based upon receipt of timing information in a respective one or more wireless satellite signals 151-1.

In processing operation 930, in response to detecting the failure condition, the communication management resource at the first wireless base station 131 updates the synchronization of the first wireless base station 131 with respect to the wireless network 111 based upon synchronization information 151 received from a backup synchronization management resource such as wireless base station 132 or other suitable entity over a backhaul 199 of the wireless network 111 in network environment 100.

Note again that techniques herein are well suited to facilitate backup synchronization of one or more failing wireless base stations in the network environment based upon synchronization information generated by one or more healthy wireless base stations in the network environment. However, it should be noted that examples herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred examples thereof, it will be understood by those skilled in the art that various changes in form and details may be made therein without departing from the spirit and scope of the present application as defined by the appended claims. Such variations are intended to be covered by the scope of this present application. As such, the foregoing description of examples of the present application is not intended to be limiting. Rather, any limitations to the invention are presented in the following claims.

I claim:

1. A method comprising:
monitoring synchronization of a first wireless base station with respect to a wireless network;
detecting a condition preventing the first wireless base station from updating synchronization of the first wireless base station with the wireless network; and
in response to detecting the condition, updating the synchronization of the first wireless base station with respect to the wireless network based upon synchronization information received over a backhaul of the wireless network.

2. The method as in claim 1, wherein monitoring synchronization includes:
monitoring receipt of wireless signals from a satellite; and
wherein the condition is an inability of the first wireless base station to receive wireless signals from the satellite.

3. The method as in claim 2, wherein the synchronization information is derived from the second wireless base station receiving the wireless signal from the satellite.

4. The method as in claim 1, wherein updating the synchronization of the first wireless base station with respect to the wireless network includes:
transmitting a notification from the first wireless base station to a communication management resource, the notification generated in response to detecting an inability of the first wireless base station to receive wireless timing signals.

5. The method as in claim 1, wherein updating the synchronization of the first wireless base station with respect to the wireless network includes: transmitting a request from the first wireless base station to a second wireless base station in the wireless network, the request being a request to handoff first user equipment from the first wireless base station to the second wireless base station.

6. The method as in claim 5 further comprising:
in response to transmitting the request, receiving the synchronization information from the second wireless base station, the synchronization information including a reference clock setting associated with the second wireless base station.

7. The method as in claim 6 further comprising:
adjusting the reference clock setting at the first wireless base station based upon a time delay associated with communicating the reference clock setting from the second wireless base station to the first wireless base station.

8. The method as in claim 5, wherein the first instance of the user equipment is an imaginary mobile communication device.

9. The method as in claim 8, wherein the imaginary mobile communication device is an emulation of the first user equipment.

10. The method as in claim 1 further comprising:
in response to detecting the condition preventing the first wireless base station from updating synchronization of the first wireless base station with the wireless network, communicating a handoff request from the first wireless base station to the second wireless base station.

11. The method as in claim 10, wherein the handoff request requests a handoff of an imaginary instance of user equipment from the first wireless base station to the second wireless base station.

12. A system comprising:
communication management hardware operative to:
monitor synchronization of a first wireless base station with respect to a wireless network;
detect a condition preventing the first wireless base station from updating synchronization of the first wireless base station with the wireless network; and
in response to detecting the condition, update the synchronization of the first wireless base station with respect to the wireless network based upon synchronization information received over a backhaul of the wireless network.

13. The system as in claim 12, wherein the communication management hardware is further operative to: monitor receipt of wireless signals from a satellite ; and
wherein the condition is an inability of the first wireless base station to receive timing information in a wireless signal from the satellite.

14. The system as in claim 13, wherein the synchronization information is derived from the second wireless base station receiving the wireless signal from the satellite.

15. The system as in claim 12, wherein the communication management hardware is further operative to:
transmit a notification from the first wireless base station to a communication management resource, the notification generated in response to detecting an inability of the first wireless base station to receive wireless timing signals.

16. The system as in claim 12, wherein the communication management hardware is further operative to:
transmit a request from the first wireless base station to a second wireless base station, the request being a request to handoff first user equipment from the first wireless base station to the second wireless base station.

17. The system as in claim 16, wherein the communication management hardware is further operative to:
in response to transmitting the request, receive the synchronization information from the second wireless base station, the synchronization information including a reference clock setting associated with the second wireless base station.

18. The system as in claim 17, wherein the communication management hardware is further operative to:
adjust the reference clock setting at the first wireless base station based upon a time delay associated with communicating the reference clock setting from the second wireless base station to the first wireless base station.

19. The system as in claim 16, wherein the first instance of the user equipment is an imaginary mobile communication device.

20. The system as in claim 19, wherein the imaginary mobile communication device is an emulation of the first user equipment.

21. The system as in claim 12, wherein the communication management hardware is further operative to:
in response to detecting the condition preventing the first wireless base station from updating synchronization of the first wireless base station with the wireless network, communicate a handoff request from the first wireless base station to a second wireless base station.

22. The system as in claim 12, wherein the handoff request requests a handoff of an imaginary instance of user equipment from the first wireless base station to the second wireless base station.

23. Computer-readable storage hardware having instructions stored thereon, the instructions, when carried out by computer processor hardware, cause the computer processor hardware to:
monitor synchronization of a first wireless base station with respect to a wireless network;
detect a condition preventing the first wireless base station from updating synchronization of the first wireless base station with the wireless network; and
in response to detecting the condition, update the synchronization of the first wireless base station with respect to the wireless network based upon synchronization information received over a backhaul of the wireless network.
